(19) United States
(12) Patent Application Publication
(10) Pub. No.: US 2013/0290590 A1
(43) Pub. Date: Oct. 31, 2013

(54) CONNECTOR ASSEMBLY

(71) Applicants: REN-HONG CHIANG, Tu-Cheng (TW); DUN-HONG CHENG, Shenzhen City (CN); JIN-XIU CHEN, Shenzhen City (CN)

(72) Inventors: REN-HONG CHIANG, Tu-Cheng (TW); DUN-HONG CHENG, Shenzhen City (CN); JIN-XIU CHEN, Shenzhen City (CN)

(21) Appl. No.: 13/663,583

(22) Filed: Oct. 30, 2012

(30) Foreign Application Priority Data
Apr. 26, 2012 (CN) 201210125607.3

(51) Int. Cl. G06F 13/00

(52) U.S. Cl. 710/302

(57) ABSTRACT

A connector assembly includes a first connector and a second connector. The first connector includes a plurality of first signal pins and a first hot-plugging detection pin. The second connector includes a plurality of second signal pins and a second hot-plugging detection pin. The first hot-plugging detection pin is configured to connect to the second hot-plugging detection pin when the plurality of first signal pins are connected to the plurality of second signal pins. The first hot-plugging detection pin is configured to disconnect from the second hot-plugging detection pin before the plurality of first signal pins are disconnected from the plurality of second signal pins.

### BACKGROUND

1. Technical Field

The present disclosure relates to connectors assemblies, and more particularly to a connector assembly which supports hot-plugging.

2. Description of Related Art

For conveniently connecting peripheral devices to a main control device, such as a computer, the hot-plugging technique is used to connect and disconnect these peripheral devices to the computer without shutting down the computer. However, directly drawing the peripheral device from the computer while the peripheral device is running may damage the peripheral device.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a sketch view of a connector assembly in accordance with an embodiment.

FIG. 2 is a sketch view of a first connector being connected to a second connector of the connector assembly of FIG. 1.

FIG. 3 is sketch view of the first connector being disconnected from the second connector of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

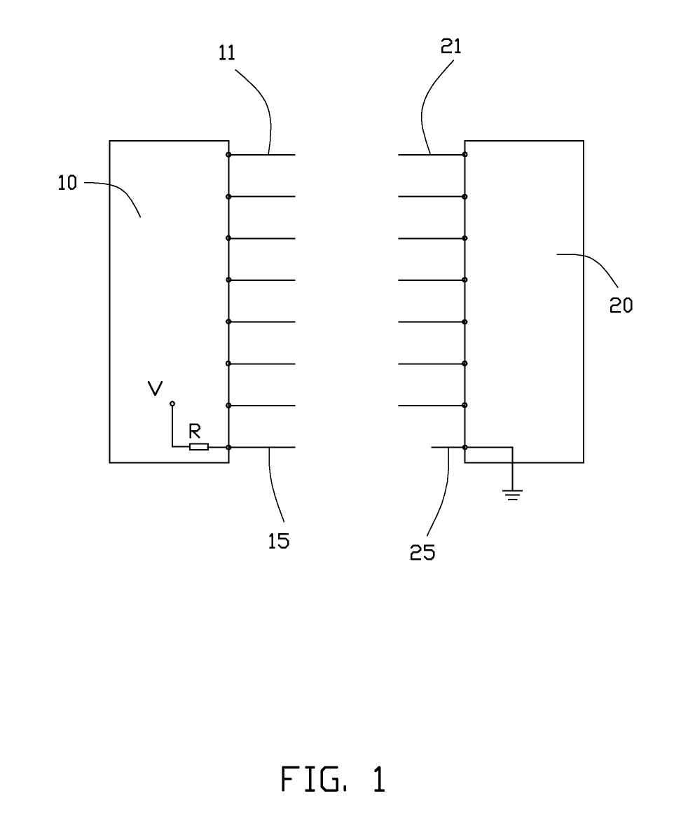

Referring to FIG. 1, a connector assembly in accordance with an embodiment includes a first connector 10 and a second connector 20. The first connector 10 and the second connector 20 are located on different electronic devices. In one embodiment, the first connector 10 is located on a computer, and the second connector 20 is resides on a peripheral device. The second connector 20 is configured to connect to the first connector 10 to transmit signals between the peripheral device and the computer.

The first connector 10 includes a plurality of first signal pins 11 and a first hot-plugging detection pin 15. A length of each of the plurality of first signal pins 11 and the first hot-plugging detection pin 15 are the same. The plurality of first signal pins 11 is configured to transmit signal, and the first hot-plugging detection pin 15 is configured to detect if the second connector 20 is connected to the first connector 10. The first hot-plugging detection pin 15 is connected to a high level voltage V via a resistor R.

The second connector 20 includes a plurality of second signal pins 21 and a second hot-plugging detection pin 25. The plurality of second signal pins 21 is configured to connect the plurality of first signal pins 11. The second hot-plugging detection pin 25 is configured to connect the first hot-plugging detection pin 15. A length of the second hot-plugging pin 25 is smaller than a length of each of the plurality of second signal pins 21. The second hot-plugging pin 25 is grounded.

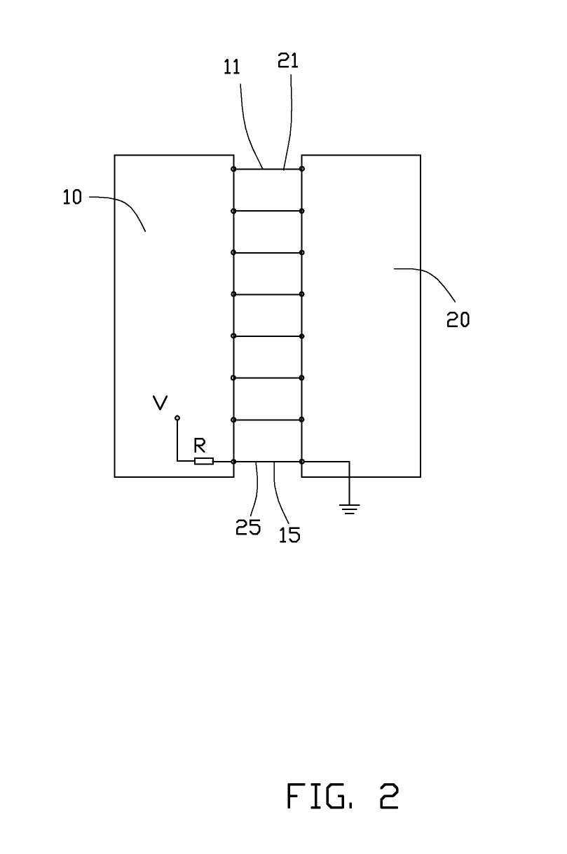

Referring to FIG. 2, when the second connector 20 of the peripheral device is connected to the first connector 10 of the computer, the plurality of second signal pins 21 is connected to the plurality of first signal pins 11, and the second hot-plugging detection pin 25 is connected to the first hot-plugging detection pin 15. The first hot-plugging detection pin 15 is connected to ground via the second hot plugging detection pin 25. After the computer detects that a voltage on the first hot-plugging detection pin 15 is at low level, the computer starts to provide power to the peripheral device and communicate with the peripheral device according the plurality of first signal pins 11 and the plurality of second signal pins 21.

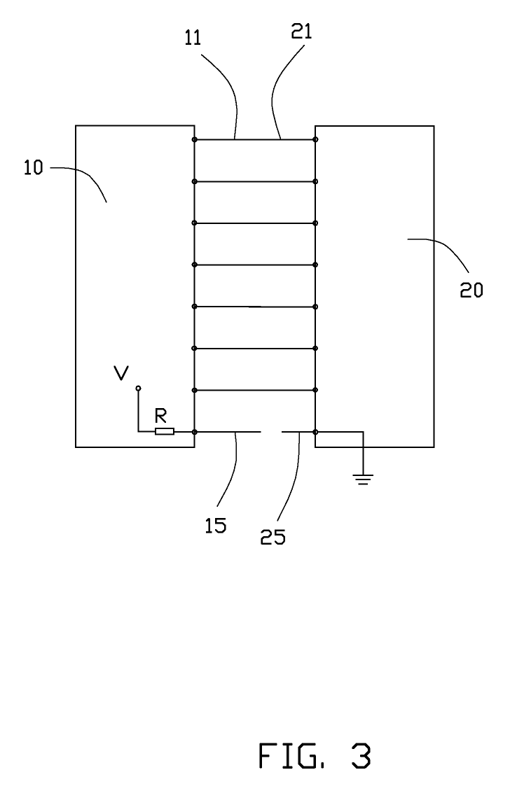

Referring to FIG. 3, because the second hot-plugging detection pin 25 is shorter than each of the second signal pins 21, as the second connector 20 of the peripheral device is disconnected from the first connector 10 of the computer, the second hot-plugging detection pin 25 disconnects from the first hot-plugging detection pin 15 before the plurality of first signal pins 11 disconnects from the plurality of second signal pins 21. When the second hot-plugging detection pin 25 disconnects from the first hot-plugging detection pin 15, the voltage on the first hot-plugging detection pin 15 becomes high level. After the computer detects that the voltage on the first hot-plugging detection pin 15 is at high level, the computer stops providing power to the peripheral device and shuts down the peripheral device.

In the connector assembly, before the plurality of second signal pins 21 of the second connector 20 is disconnected from the plurality of first signal pins 11 of the first connector 10, the computer detects voltage variation on the first hot-plugging detection pin 15 from low to high to stop provide power to the peripheral device and shut down the peripheral device. Therefore, the peripheral device is protected.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A connector assembly, comprising:
a first connector comprising a plurality of first signal pins and a first hot-plugging detection pin;
a second connector comprising a plurality of second signal pins and a second hot-plugging detection pin;
wherein the first hot-plugging detection pin is configured to connect to the second hot-plugging detection pin when the plurality of first signal pins are connected to the plurality of second signal pins, and the first hot-plugging detection pin is configured to disconnect from the second hot-plugging detection pin before the plurality of first signal pins are disconnected from the plurality of second signal pins.

2. The connector assembly of claim 1, wherein a length of the first hot-plugging pin is equal to a length of each of the plurality of first signal pins, and a length of the second hot-plugging pin is smaller than a length of each of the plurality of second signal pins.

3. The connector assembly of claim 2, wherein the first hot-plugging detection pin is connected to a high level voltage via a resistor, and the second hot-plugging detection pin is grounded.

4. The connector assembly of claim 3, wherein the first hot-plugging detection pin is configured to connect to ground via the second hot-plugging detection pin when the plurality of first signal pins are connected to the plurality of second signal pins.

5. The connector assembly of claim 3, wherein a voltage on the first hot-plugging detection pin is at the high level voltage when the first hot-plugging detection pin is disconnected from the second hot-plugging detection pin.

6. A connector assembly, comprising:
a first connector comprising a first signal pin and a first hot-plugging detection pin, a length of the first hot-plugging pin being equal to a length of the first signal pin;
a second connector comprising a second signal pin and a second hot-plugging detection pin, a length of the second hot-plugging pin being smaller than a length of the second signal pin;
wherein the first hot-plugging detection pin is configured to connect to the second hot-plugging detection pin when the first signal pin is connected to the second signal pin, and the first hot-plugging detection pin is configured to disconnect from the second hot-plugging detection pin before the first signal pin is disconnected from the second signal pin.

7. The connector assembly of claim 6, wherein the first hot-plugging detection pin is connected to a high level voltage via a resistor, and the second hot-plugging detection pin is grounded.

8. The connector assembly of claim 7, wherein the first hot-plugging detection pin is configured to connect to ground via the second hot-plugging detection pin when the first signal pin is connected to the second signal pin.

9. The connector assembly of claim 7, wherein a voltage on the first hot-plugging detection pin is at the high level voltage when the first hot-plugging detection pin is disconnected from the second hot-plugging detection pin.
